(19) United States
(12) Patent Application Publication
(10) Pub. No.: US 2021/0339812 A1
(43) Pub. Date: Nov. 4, 2021

(54) VEHICLE SEAT SYSTEM WITH STOWABLE BACK SUPPORT

(71) Applicants: Nathan D. Labrecque, Milford, NH (US); David A. Cicotte, Milford, NH (US)

(72) Inventors: Nathan D. Labrecque, Milford, NH (US); David A. Cicotte, Milford, NH (US)

(21) Appl. No.: 17/245,732

(22) Filed: Apr. 30, 2021

Related U.S. Application Data
(60) Provisional application No. 63/101,407, filed on Apr. 30, 2020.

(51) Int. Cl. B62J 1/12; B62J 1/28

(52) U.S. Cl. CPC B62J 1/12; B62J 1/28

(57) ABSTRACT

A vehicle seat system is disclosed. The disclosed system may include a stowable back support portion configured to interface with the back of a user (e.g., a passenger and/or driver, as desired). In some embodiments, the support portion may be connected to a guide system for stowing within an interior hollow of the secondary seat portion (e.g., pillion) of a vehicle seat. In some other embodiments, the support portion may be a separate structure configured to be removably stored within the interior hollow and installed at a corresponding mounting site on the vehicle seat or host platform. In some still other embodiments, the support portion may be a rearward portion of the vehicle seat which is attached to the remainder of the vehicle seat by a hinge or other pivoting element which permits the rearward portion to rotate into position.

### CROSS-REFERENCE TO RELATED APPLICATION

This patent application claims the benefit of U.S. Provisional Patent Application No. 63/101,407, titled “Motorcycle Seat that Offers Stowaway Passenger and or Driver Back Rest,” filed on Apr. 30, 2020, which is herein incorporated by reference in its entirety.

### FIELD OF THE DISCLOSURE

The present disclosure relates to vehicle seat systems and, more particularly, to seat systems for motorcycles and the like.

### BACKGROUND

Modern motorcycles typically have a saddle-type seat designed for accommodating a driver. In some instances, an additional seat area—known as a pillion—is provided for accommodating a passenger. The pillion normally is provided directly behind the driver's seat, often offset at a vertically elevated position. When seated on the pillion, a passenger may opt to physically hold onto the driver to help secure himself/herself while in transit.

### SUMMARY

The subject matter of this application may involve, in some cases, interrelated products, alternative solutions to a particular problem, and/or a plurality of different uses of a single system or article.

One example embodiment provides a vehicle seat system. The system includes a main seat portion. The system also includes a secondary seat portion disposed adjacent the main seat portion, wherein the secondary seat portion includes an interior hollow. The system further includes a support assembly. The support assembly includes at least one guide disposed within the interior hollow. The support assembly also includes at least one connector operatively engaged with the at least one guide. The support assembly further includes a support portion operatively coupled with the at least one connector, wherein the support portion is configured to interface with a back region of a user and to be stowed within the interior hollow.

In some cases, the at least one connector is operatively engaged with the at least one guide in a slidable manner. In some cases, the at least one connector is operatively engaged with the at least one guide in a rollable manner. In some cases, the at least one connector is operatively engaged with the at least one guide in a telescoping manner.

In some cases, the support assembly further includes at least one pivot joint operatively coupled with the at least one connector and the support portion, wherein the at least one pivot joint is configured to allow the support portion to rotate from a horizontal position to a vertical position through an angle in the range of 0° to 90°. In some cases, the support assembly further includes at least one pivot joint operatively coupled with the at least one connector and the support portion, wherein the at least one pivot joint is configured to allow the support portion to rotate from a horizontal position to a vertical position through an angle in the range of 90° to 150°.

In some cases, the support assembly further includes at least one extension operatively coupled with the at least connector and the support portion and configured to allow the support portion to extend away from the secondary seat portion.

In some cases, the system further includes an enclosure disposed at an end of the secondary seat portion and configured to enclose the interior hollow. In some cases, the support portion is configured to occupy an entry of the interior hollow so as to enclose the interior hollow while the support portion is stowed within the interior hollow.

Another example embodiment provides a vehicle seat system. The system includes a main seat portion. The system also includes a secondary seat portion disposed adjacent the main seat portion, wherein the secondary seat portion includes an interior hollow. The system further includes a support assembly. The support assembly includes a support portion configured to interface with a back region of a user and to be stowed within the interior hollow. The support assembly also includes at least one connector operatively coupled with the support portion and configured to be mounted at a mounting site external to the interior hollow.

In some cases, the mounting site includes a receiver element native to a platform hosting the vehicle seat system, wherein the receiver element is configured to receive and retain the at least one connector. In some such instances, the receiver element includes a recess configured for insertion of the at least one connector therein.

In some cases, the support assembly further includes at least one pivot joint operatively coupled with the at least one connector and the support portion, wherein the at least one pivot joint is configured to allow the support portion to rotate from a horizontal position to a vertical position through an angle in the range of 0° to 90°. In some cases, the support assembly further includes at least one pivot joint operatively coupled with the at least one connector and the support portion, wherein the at least one pivot joint is configured to allow the support portion to rotate from a horizontal position to a vertical position through an angle in the range of 90° to 150°.

In some cases, the support assembly further includes at least one extension operatively coupled with the at least connector and the support portion and configured to allow the support portion to extend away from the secondary seat portion.

In some cases, the system further includes an enclosure disposed at an end of the secondary seat portion and configured to enclose the interior hollow. In some cases, the support portion is configured to occupy an entry of the interior hollow so as to enclose the interior hollow while the support portion is stowed within the interior hollow.

Another example embodiment provides a vehicle seat system. The system includes a main seat portion. The system also includes a secondary seat portion disposed adjacent the main seat portion, wherein a tail portion of the secondary seat portion is attached to a remainder of the secondary seat portion via a pivot joint configured to allow the tail portion to rotate through an angle in the range of 0° to 90°, wherein the tail portion is configured to interface with a back region of a user.

In some cases, the pivot joint is configured to allow the tail portion to rotate through an angle in the range of 0° to 150°.

In some cases, the secondary seat portion is at an elevated position as compared to the main seat portion.

The features and advantages described herein are not all-inclusive and, in particular, many additional features and advantages will be apparent to one of ordinary skill in the art in view of the drawings, specification, and claims. Moreover, it should be noted that the language used in the specification has been selected principally for readability and instructional purposes and not to limit the scope of the inventive subject matter.

### BRIEF DESCRIPTION OF THE DRAWINGS

FIG. 1 illustrates a perspective view of a vehicle seat system configured in accordance with an embodiment of the present disclosure.

FIG. 2 illustrates a close-up view of a portion of the system of FIG. 1.

FIG. 3 illustrates a side elevation view of the system of FIG. 1.

FIG. 4 illustrates a rear elevation view of the system of FIG. 1.

FIG. 5 illustrates a side elevation view of the system of FIG. 1 optionally including an enclosure, in accordance with an embodiment of the present disclosure.

FIGS. 6A-6D illustrate example operation of the system of FIG. 1, in accordance with an embodiment of the present disclosure.

FIGS. 7-8 illustrate perspective views of a vehicle seat system configured in accordance with another embodiment of the present disclosure.

FIGS. 9-10 illustrate perspective views of a vehicle seat system configured in accordance with another embodiment of the present disclosure.

FIG. 11 illustrates a side elevation view of a vehicle seat system configured in accordance with another embodiment of the present disclosure.

These and other features of the present embodiments will be understood better by reading the following detailed description, taken together with the figures herein described. In the drawings, each identical or nearly identical component that is illustrated in various figures may be represented by a like numeral. For purposes of clarity, not every component may be labeled in every drawing. Furthermore, as will be appreciated in light of this disclosure, the accompanying drawings are not intended to be drawn to scale or to limit the described embodiments to the specific configurations shown.

### DETAILED DESCRIPTION

A vehicle seat system is disclosed. The disclosed system may include a stowable back support portion configured to interface with the back of a user (e.g., a passenger and/or driver, as desired). In some embodiments, the support portion may be connected to a guide system for stowing within an interior hollow of the secondary seat portion (e.g., pillion) of a vehicle seat. In some other embodiments, the support portion may be a separate structure configured to be removably stored within the interior hollow and installed at a corresponding mounting site on the vehicle seat or host platform. In some still other embodiments, the support portion may be a rearward portion of the vehicle seat which is attached to the remainder of the vehicle seat by a hinge or other pivoting element which permits the rearward portion to rotate into position. Numerous configurations and variations will be apparent in light of this disclosure.

### General Overview

In accordance with some embodiments of the present disclosure, a vehicle seat system is disclosed. The disclosed system may include a stowable back support portion configured to interface with the back of a user (e.g., a passenger and/or driver, as desired). In some embodiments, the support portion may be connected to a guide system for stowing within an interior hollow of the secondary seat portion (e.g., pillion) of a vehicle seat. In some other embodiments, the support portion may be a separate structure configured to be removably stored within the interior hollow and installed at a corresponding mounting site on the vehicle seat or host platform. In some still other embodiments, the support portion may be a rearward portion of the vehicle seat which is attached to the remainder of the vehicle seat by a hinge or other pivoting element which permits the rearward portion to rotate into position.

As discussed herein, the disclosed system generally may be configured for use as (1) a backrest or lumbar support and/or (2) a physical brace for a passenger sitting on the pillion of a host platform or, in some instances, for the driver. In this sense, the disclosed system may be configured to serve as a safety feature that prevents (or otherwise reduces) the opportunity for a user to slide off the rear of the host platform (e.g., during acceleration or maneuvering). Thus, at least in some instances, the disclosed system may be considered an alternative to a traditional “sissy bar” utilized for some vehicles. Furthermore, as discussed herein, the disclosed system may be configured for use with any of a wide range of host platforms, including, but not limited to, motorcycles, dirt bikes, all-terrain vehicle (ATV), scooters, mopeds, snowmobiles, and personal watercrafts. Moreover, in accordance with some embodiments, the disclosed system may be integrated with a given host platform or may be retrofitted to a given host platform, as desired. Numerous suitable uses and applications will be apparent in light of this disclosure.

As will be appreciated in light of this disclosure, the disclosed system may have a number of advantages and benefits over existing approaches. For instance, in at least some cases, the disclosed system may be configured to help maintain the visual cleanliness/aesthetics of the host platform by remaining hidden from sight when the back support portion is not in use. In at least some cases, the disclosed system may be configured to be adjustable in height and/or angle, to accommodate users of different size, ability, and comfort level. In at least some cases, the disclosed system may be configured to be sealed when stowed, protecting against environmental hazards (e.g., moisture, dust, pests, etc.). In some instances, a seat system provided using the disclosed techniques may be configured, for example, as: (1) a partially/completely assembled seat system unit; and/or (2) a kit or other collection of discrete components (e.g., seat portion, support assembly, etc.) which may be operatively coupled as desired. Additional and/or different advantages and benefits will be apparent in light of this disclosure.

### Structure and Operation

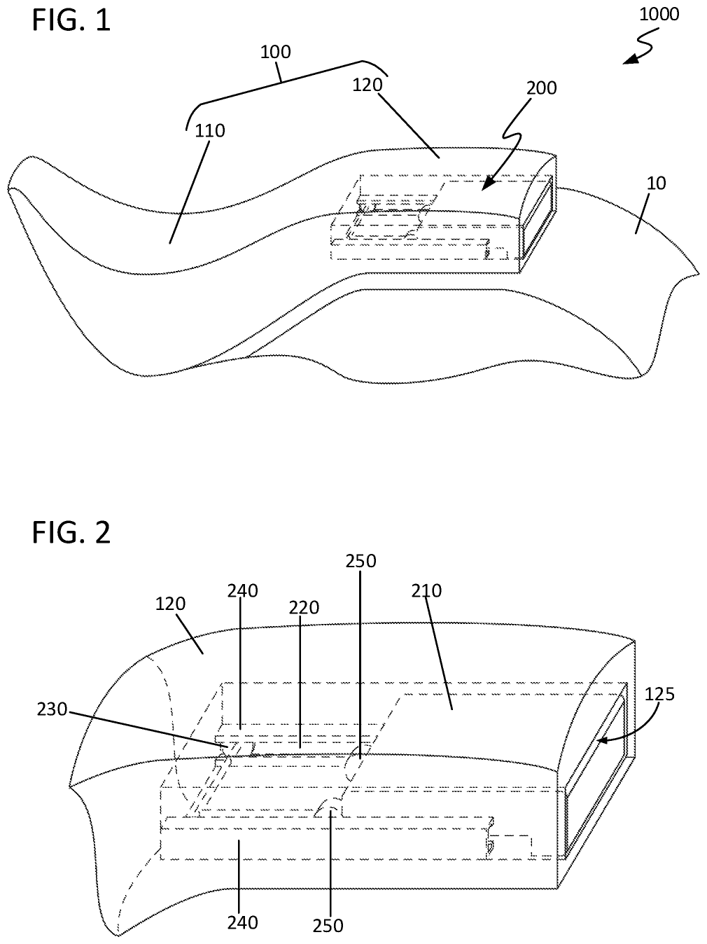

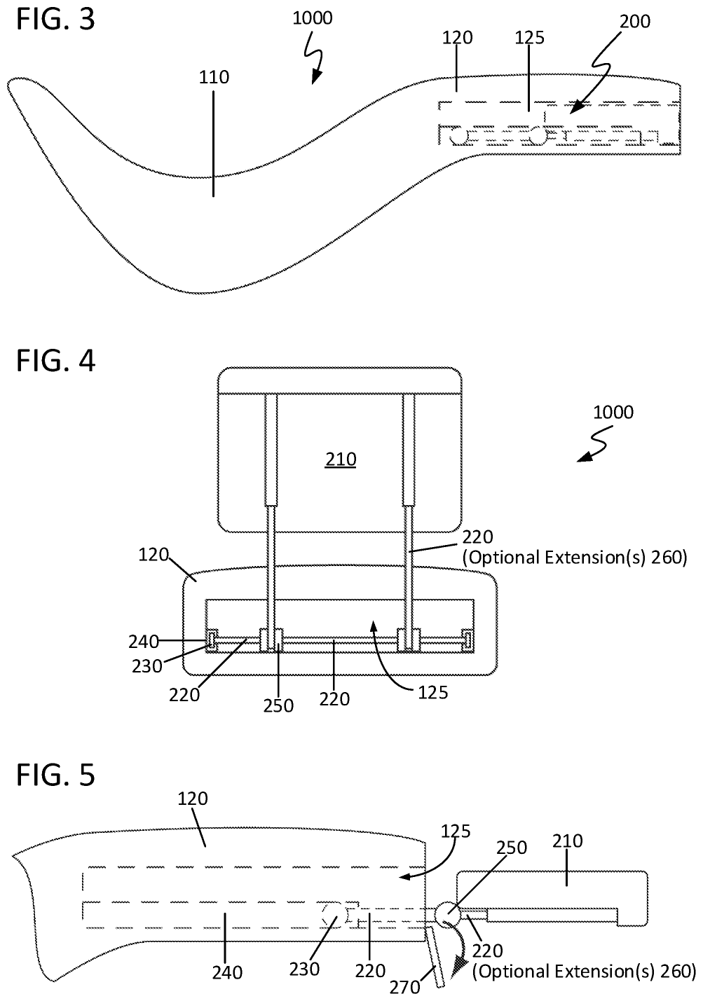

FIGS. 1-4 illustrate several views of a vehicle seat system 1000 configured in accordance with an embodiment of the present disclosure. As can be seen from these figures, system 1000 may include a seat portion 100 including a main seat portion 110 (e.g., a forward seat portion for a driver) and a secondary seat portion 120 (e.g., a rearward seat portion for a passenger). As can be seen further, system 1000 also may include a support assembly 200 which is stowable (in part or in whole) within seat portion 100 (e.g., proximate secondary seat portion 120). Each of these elements is discussed in turn below. System 1000 may be configured for interfacing with a fender or chassis of a host platform 10.

In accordance with some embodiments, seat portion 100 generally may be configured like a typical saddle-type seat, including a main seat portion 110 (e.g., a forward seat or saddle for a driver) and a secondary seat portion 120 (e.g., a rear seat or pillion for a passenger). Seat portion 100 may be configured to be disposed along the top of a chassis or fender of a given host platform 10 (e.g., a motorcycle). In some cases, seat portion 100 may be configured as a single elongated seat, whereas in some other cases, seat portion 100 may be configured with two (or more) separate adjacent seats. In some cases, seat portion 100 may be configured as a dual saddle or bench seat. As will be appreciated in light of this disclosure, the specific profile/contour of seat portion 100 (e.g., of main seat portion 110 and/or secondary seat portion 120) may be customized, as desired for a given target application or end-use. For instance, seat portion 100 may be provided with a profile/contour that is (in part or in whole) flat, curved, faceted, concave, and/or convex, among other options. In some instances, seat portion 100 may be native to host platform 10, whereas in other instances, seat portion 100 may be retrofitted (e.g., as an aftermarket component) on host platform 10. Other suitable configurations for seat portion 100 will depend on a given target application or end-use and will be apparent in light of this disclosure.

In accordance with some embodiments, seat portion 100 may have an interior hollow 125 configured to stow (in part or in whole) support assembly 200 (discussed below). Interior hollow 125 may reside substantially (e.g., entirely or primarily) beneath secondary seat portion 120. As will be appreciated in light of this disclosure, the dimensions and geometry of interior hollow 125 may be customized, as desired for a given target application or end-use. In some cases, interior hollow 125 may be substantially box-like in shape (e.g., a rectangular prism). In some cases, interior hollow 125 may be substantially U-shaped (e.g., a parabolic prism). In some cases, interior hollow 125 may be substantially arc-shaped (e.g., a semicircular or semicylindrical prism). Other suitable configurations for interior hollow 125 will depend on a given target application or end-use and will be apparent in light of this disclosure.

As noted above, system 1000 may include a support assembly 200. In accordance with some embodiments, support assembly 200 may include a support portion 210 interfaced with one or more connectors 220, which in turn are interfaced with one or more guides 240. Support portion 210 may be configured, in accordance with some embodiments, to interface with the back (e.g., lumbar region) and/or hips of a user (e.g., a passenger or a driver). To that end, support portion 210 optionally may be contoured and/or cushioned, as desired (e.g., for comfort and safety of the user). In a more general sense, support portion 210 may be configured as a backrest (e.g., offering back support to a user).

As noted above, support assembly 200 may be configured, in accordance with some embodiments, to be stowed (in part or in whole) within interior hollow 125 of seat portion 100. In some embodiments, support portion 210 may be configured to be manually withdrawn from interior hollow 125. In some embodiments, support portion 210 may be configured to exit interior hollow 125 via spring-loading or other suitable biasing means. Other suitable configurations for support portion 210 will depend on a given target application or end-use and will be apparent in light of this disclosure.

In some embodiments, a single connector 220 (e.g., a single bar, plate, rod, or bracket) may be connected to support portion 210 and operatively engaged with guide(s) 240. In some embodiments, multiple connectors 220 (e.g., bars, plates, rods, and/or brackets) may be connected to support portion 210 and operatively engaged with guide(s) 240. In some embodiments, connector(s) 220 may be slidably interfaced with guide(s) 240. In some embodiments, connector(s) 220 may be interfaced with guide(s) 240 via one or more rolling elements (e.g., wheels and/or bearings). In some embodiments, connector(s) 220 may be interfaced with guide(s) 240 in a telescoping or other collapsible manner. Other suitable configurations for connector(s) 220 will depend on a given target application or end-use and will be apparent in light of this disclosure.

Also, as can be seen, support assembly 200 may include one or more pivot joints 250 about which support portion 210 may be permitted to rotate (e.g., flip upward) relative to connector(s) 220 (or secondary seat portion 120 more generally). The angular range of rotational motion permitted by pivot joint(s) 250 may be customized, as desired for a given target application or end-use. For instance, in some embodiments, pivot joint(s) 250 may permit support portion 210 to rotate through an angle (θ) in the range of about 0°-90° (e.g., about 0°-30°, about 30°-45°, about 45°-60°, about 60°-90°, or any other sub-range in the range of about 0°-90°). In some embodiments, pivot joint(s) 250 may permit support portion 210 to rotate through an angle (θ) in the range of about 90°-150°, such that support portion 210 tilts forward more toward main seat portion 110. In some instances, angular positioning intervals for pivot joint(s) 250 may be pre-set and selectable, whereas in other instances, fully customized angular positions may be achieved as desired.

In some cases, pivot joint(s) 250 may include a locking mechanism which serves to fix support portion 210 at a given angle. Ratchet, friction, screw, clamp, pin, or other suitable means for locking in place may be employed, in accordance with some embodiments. The locking mechanism may be integrated with pivot joint(s) 250 or externally applied thereto in securing pivot joint(s) 250 at a given angle. Other suitable configurations for pivot joint(s) 250 will depend on a given target application or end-use and will be apparent in light of this disclosure.

As can be seen further, connector(s) 220 may include one or more stops 230 at their ends situated opposite pivot joint(s) 250. Stop(s) 230 may be configured, in accordance with some embodiments, to interface with guide(s) 240 to prevent connector(s) 220 from being withdrawn too far from guide(s) 240. More generally, stop(s) 230 may be configured, in accordance with some embodiments, to define the maximum distance which support portion 210 may be withdrawn from interior hollow 125. Other suitable configurations for stop(s) 230 will depend on a given target application or end-use and will be apparent in light of this disclosure.

In some embodiments, support assembly 200 optionally may include one or more extensions 260 interfaced with (or integrated with) connector(s) 220 and support portion 210. A given extension 260 may be configured, in accordance with some embodiments, to further increase the maximum distance between support portion 210 and seat portion 100. In some embodiments, a single extension 260 (e.g., a single bar, plate, rod, or bracket) may be connected to support portion 210 and operatively engaged with connector(s) 220 (e.g., at pivot joint(s) 250). In some embodiments, multiple extensions 260 (e.g., bars, plates, rods, and/or brackets) may be connected to support portion 210 and operatively engaged with connector(s) 220 (e.g., at pivot joint(s) 250). In some embodiments, extension(s) 260 may be slidably interfaced with connector(s) 220. In some embodiments, extension(s) 260 may be interfaced with connector(s) 220 via one or more rolling elements (e.g., wheels and/or bearings). In some embodiments, extension(s) 260 may be interfaced with connector(s) 220 in a telescoping or other collapsible manner. Other suitable configurations for optional extension(s) 260 will depend on a given target application or end-use and will be apparent in light of this disclosure.

In some embodiments, system 1000 optionally may include an enclosure 270 for interior hollow 125. For instance, consider FIG. 5, which illustrates the vehicle seat system 1000 of FIG. 1 optionally including an enclosure 270, in accordance with an embodiment of the present disclosure. As can be seen, enclosure 270 may be situated proximate the entry to interior hollow 125 (e.g., at the tail end of secondary seat portion 120). Enclosure 270 may be configured, in accordance with some embodiments, to substantially close interior hollow 125 when support portion 210 is stowed therein. Generally, enclosure 270 may be configured to conceal (e.g., visually) support assembly 200 within interior hollow 125. Enclosure 270 also may be configured to seal support assembly 200 within interior hollow 125 to protect against environmental hazards (e.g., moisture, dust, pests, etc.). In some embodiments, enclosure 270 may be operatively interfaced with seat portion 100 via a hinge. In some embodiments, enclosure 270 may be detachable from (re-attachable to) seat portion 100.

In some embodiments, enclosure 270 may be configured to be manually operated, whereas in some other embodiments, enclosure 270 may be configured to be mechanically or electronically operated. In accordance with some embodiments, when support portion 210 is withdrawn from interior hollow 125, enclosure 270 may be physically deflected from a fully closed position. In some embodiments, enclosure 270 may be configured to remain in a displaced or non-displaced position, for example, by means of a cam, detent, or other suitable mechanical feature. In some embodiments, enclosure 270 may be configured to be latched in place in a given displaced or non-displaced position. In some embodiments, enclosure 270 may be biased, such as by a spring or other suitable means, to remain in a given displaced or non-displaced position. In some embodiments, the upper end (e.g., top edge or face) of support portion 210 may be configured to serve as an enclosure 270 for interior hollow 125. In some embodiments, enclosure 270 may include a plate, door, or piece of seat covering material that is attachable using one or more fastening elements, such as snaps, magnets, or hook-and-loop fastener material (e.g., such as that produced by Velcro Corporation). Other suitable configurations for optional enclosure 270 will depend on a given target application or end-use and will be apparent in light of this disclosure.

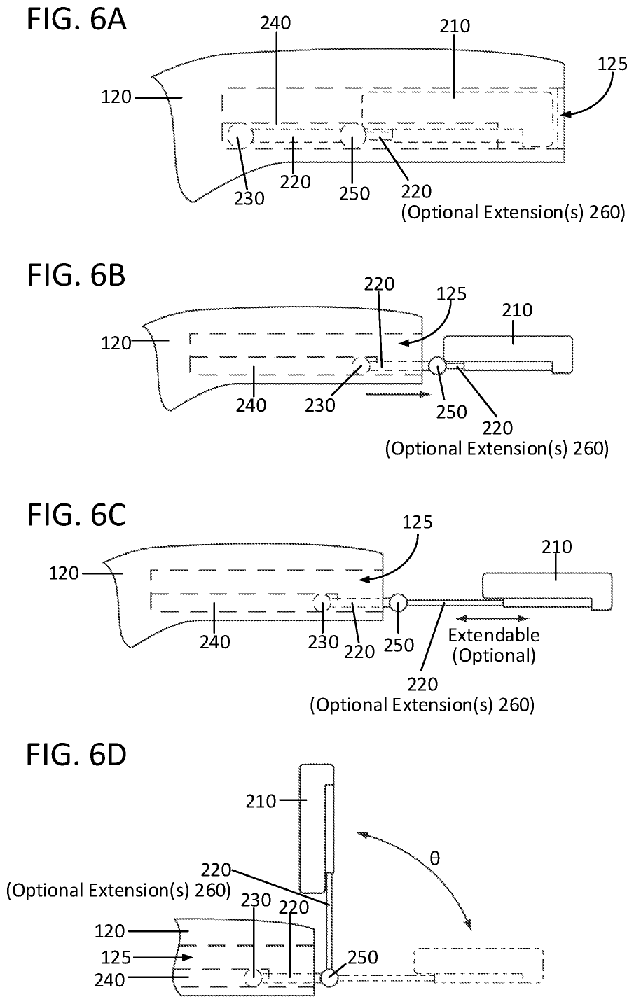

FIGS. 6A-6D illustrate example operation of vehicle seat system 1000 of FIG. 1, in accordance with an embodiment of the present disclosure. As can be seen from FIG. 6A, support portion 210 may begin in a stowed (e.g., partially or fully stowed) position within interior hollow 125. More specifically, in at least some cases, support portion 210 may be stowed in a substantially horizontal position within interior hollow 125, though in other cases, support portion 210 may be stowed at an angle offset from horizontal. As can be seen from FIG. 6B, support portion 210 may be withdrawn from interior hollow 125, with connector(s) 220 and stop(s) 230 moving along guide(s) 240. At the fully withdrawn position, stop(s) 230 may interface with the end(s) of guide(s) 240 such that support portion 210 can be withdrawn no further (e.g., unless being disassembled for cleaning, repair, or replacement). As can be seen from FIG. 6C, in cases where support portion 210 optionally includes extension(s) 260, such extension(s) 260 may be extended a given distance to further distance support portion 210 from seat portion 100. Extension(s) 260 may lock support portion 210 at a desired distance. As can be seen from FIG. 6D, support portion 210 may be rotated through an angle (θ) about pivot joint(s) 250, as discussed above. Pivot joint(s) 250 may lock support portion 210 at a desired angle. For instance, support portion 210 may be adjusted to a vertical position (e.g., 90°) or a given intermediate position (e.g., 30°, 45°, 60°, 75°) relative to horizontal or otherwise, as desired. As will be appreciated in light of this disclosure, rotation and extension for support portion 210 may be done sequentially (in either order) or simultaneously, as desired.

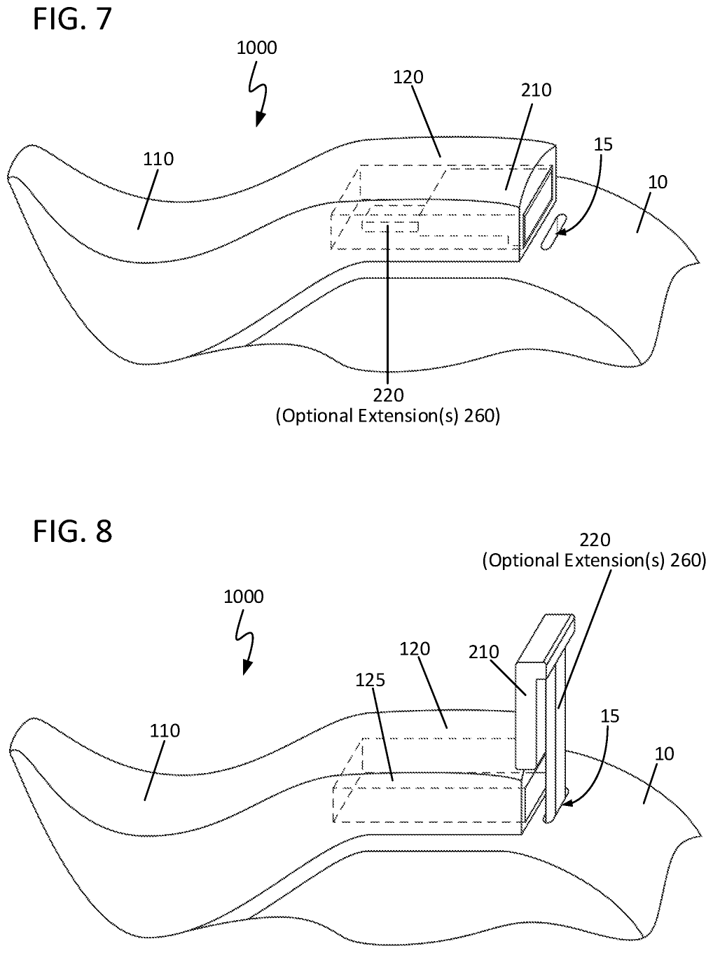

FIGS. 7-8 illustrate a vehicle seat system 1000 configured in accordance with another embodiment of the present disclosure. As can be seen, rather than a full support assembly 200 as discussed above, system 1000 may include a seat portion 100 and only a support portion 210 and one or more connectors 220, configured as variously described above. In such cases, support portion 210 may be fully removable from (e.g., not fixedly attached to) interior hollow 125. In some instances, pivot joint(s) 250 and/or extension(s) 260 optionally may be included. As can be seen further, connector(s) 220 may be interfaced with (e.g., inserted into, mated with, snap-fitted to, screwed into, etc.) a corresponding mounting site 15 (e.g., slot, hole, aperture, recess, or other receiver). In some cases, mounting site 15 may be integrated into host platform 10 (e.g., at a rear fender or rear portion of the chassis thereof).

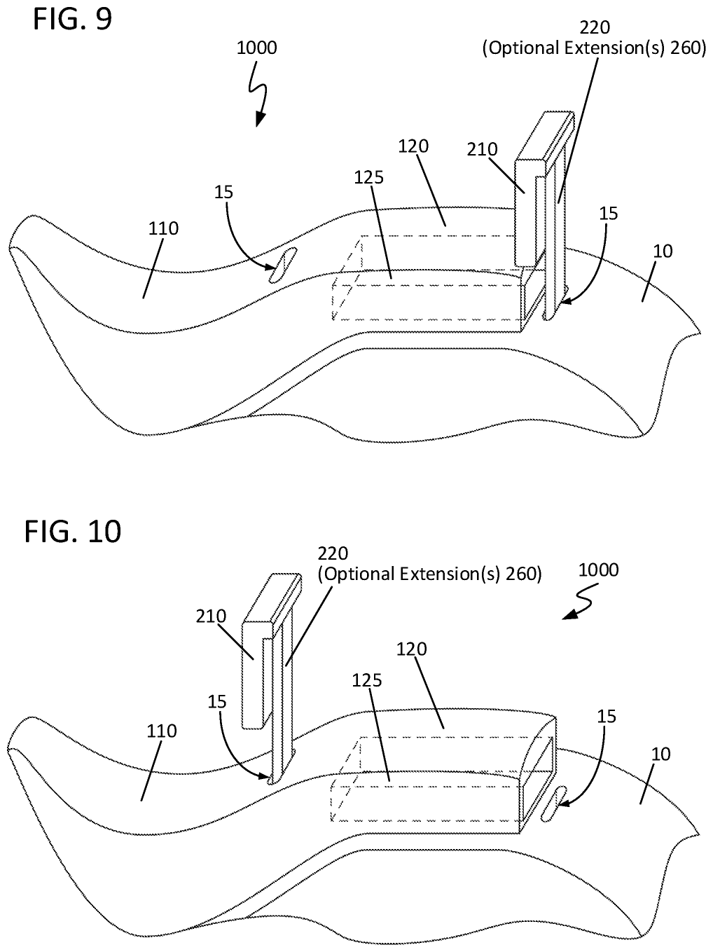

FIGS. 9-10 illustrate a vehicle seat system 1000 configured in accordance with another embodiment of the present disclosure. As can be seen, much like with the embodiment described in relation to FIGS. 7-8, a mounting site 15 for connector(s) 220 of support portion 210 may be provided proximal to secondary seat portion 120. Here, however, an additional mounting site 15 may be provided proximal to main seat portion 110. In this manner, support portion 210 may be utilized in either the forward mounting site 15 or the rearward mounting site 15, as desired. Additionally (or alternatively), a first support portion 210 may be utilized in the forward mounting site 15 while a second support portion 210 simultaneously may be utilized in the rearward mounting site 15.

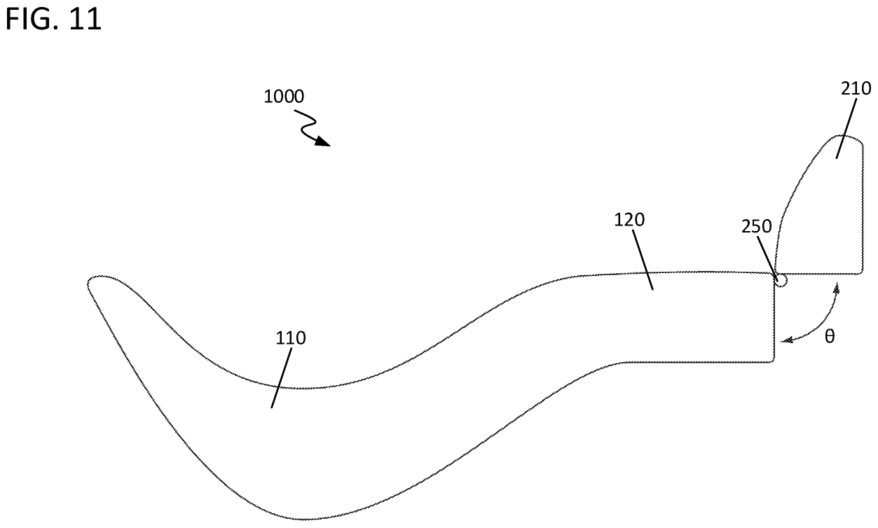

FIG. 11 illustrates a side elevation view of a vehicle seat system 1000 configured in accordance with another embodiment of the present disclosure. As can be seen here, support portion 210 may be a portion (e.g., tailpiece) of secondary seat portion 120 which is connected to the remainder of secondary seat portion 120 via one or more pivot joint(s) 250. In this manner, support portion 210 may be rotated through an angle (θ) into position at the tail end of seat portion 100. An interior hollow 125 optionally may be provided, though is not required.

### Example Applications and Use Contexts

As will be appreciated in light of this disclosure, the disclosed vehicle seat system 1000 may be configured for use with any of a wide range of host platforms 10. For example, as generally discussed herein, system 1000 may be utilized with a motorcycle (or similar vehicle), in accordance with some embodiments. It should be noted, however, that the present disclosure is not intended to be so limited, as in a more general sense, system 1000 may be configured, in accordance with some embodiments, for use with a variety of a host platforms 10 (motorized and/or human-powered), such as, for instance, dirt bikes, mopeds, scooters, all-terrain vehicles (ATVs), snowmobiles, and personal watercrafts, to name a few options.

As will be further appreciated in light of this disclosure, the disclosed vehicle seat system 1000 may be configured, in accordance with some embodiments, as a retrofit system to be interfaced with (e.g., attached to, mounted to, installed on, etc.) a given host platform 10. In some embodiments, system 1000 may be retrofitted to a pre-existing seat of a host platform. It should be noted, however, that the present disclosure is not intended to be so limited, as system 1000 optionally may be integrated, in part or in whole, into a given host platform 10. For instance, system 1000 may be integrated, in part or in whole, with the fender or chassis of a host platform 10.

The foregoing description of example embodiments has been presented for the purposes of illustration and description. It is not intended to be exhaustive or to limit the present disclosure to the precise forms disclosed. Many modifications and variations are possible in light of this disclosure. It is intended that the scope of the present disclosure be limited not by this detailed description. Future-filed applications claiming priority to this application may claim the disclosed subject matter in a different manner and generally may include any set of one or more limitations as variously disclosed or otherwise demonstrated herein.

What is claimed is:

1. A vehicle seat system comprising:
a main seat portion;
a secondary seat portion disposed adjacent the main seat portion, wherein the secondary seat portion includes an interior hollow; and
a support assembly comprising:
at least one guide disposed within the interior hollow;
at least one connector operatively engaged with the at least one guide; and
a support portion operatively coupled with the at least one connector, wherein the support portion is configured to interface with a back region of a user and to be stowed within the interior hollow.

2. The vehicle seat system of claim 1, wherein the at least one connector is operatively engaged with the at least one guide in a slidable manner.

3. The vehicle seat system of claim 1, wherein the at least one connector is operatively engaged with the at least one guide in a rollable manner.

4. The vehicle seat system of claim 1, wherein the at least one connector is operatively engaged with the at least one guide in a telescoping manner.

5. The vehicle seat system of claim 1, wherein the support assembly further comprises at least one pivot joint operatively coupled with the at least one connector and the support portion, wherein the at least one pivot joint is configured to allow the support portion to rotate from a horizontal position to a vertical position through an angle in the range of 0° to 90°.

6. The vehicle seat system of claim 1, wherein the support assembly further comprises at least one pivot joint operatively coupled with the at least one connector and the support portion, wherein the at least one pivot joint is configured to allow the support portion to rotate from a horizontal position to a vertical position through an angle in the range of 90° to 150°.

7. The vehicle seat system of claim 1, wherein the support assembly further comprises at least one extension operatively coupled with the at least connector and the support portion and configured to allow the support portion to extend away from the secondary seat portion.

8. The vehicle seat system of claim 1, further comprising an enclosure disposed at an end of the secondary seat portion and configured to enclose the interior hollow.

9. The vehicle seat system of claim 1, wherein the support portion is configured to occupy an entry of the interior hollow so as to enclose the interior hollow while the support portion is stowed within the interior hollow.

10. A vehicle seat system comprising:
a main seat portion;
a secondary seat portion disposed adjacent the main seat portion, wherein the secondary seat portion includes an interior hollow; and
a support assembly comprising:
a support portion configured to interface with a back region of a user and to be stowed within the interior hollow; and
at least one connector operatively coupled with the support portion and configured to be mounted at a mounting site external to the interior hollow.

11. The vehicle seat system of claim 10, wherein the mounting site comprises a receiver element native to a platform hosting the vehicle seat system, wherein the receiver element is configured to receive and retain the at least one connector.

12. The vehicle seat system of claim 11, wherein the receiver element comprises a recess configured for insertion of the at least one connector therein.

13. The vehicle seat system of claim 10, wherein the support assembly further comprises at least one pivot joint operatively coupled with the at least one connector and the support portion, wherein the at least one pivot joint is configured to allow the support portion to rotate from a horizontal position to a vertical position through an angle in the range of 0° to 90°.

14. The vehicle seat system of claim 10, wherein the support assembly further comprises at least one pivot joint operatively coupled with the at least one connector and the support portion, wherein the at least one pivot joint is configured to allow the support portion to rotate from a horizontal position to a vertical position through an angle in the range of 90° to 150°.

15. The vehicle seat system of claim 10, wherein the support assembly further comprises at least one extension operatively coupled with the at least connector and the support portion and configured to allow the support portion to extend away from the secondary seat portion.

16. The vehicle seat system of claim 10, further comprising an enclosure disposed at an end of the secondary seat portion and configured to enclose the interior hollow.

17. The vehicle seat system of claim 10, wherein the support portion is configured to occupy an entry of the interior hollow so as to enclose the interior hollow while the support portion is stowed within the interior hollow.

18. A vehicle seat system comprising:
a main seat portion; and
a secondary seat portion disposed adjacent the main seat portion, wherein a tail portion of the secondary seat portion is attached to a remainder of the secondary seat portion via a pivot joint configured to allow the tail portion to rotate through an angle in the range of 0° to 90°, wherein the tail portion is configured to interface with a back region of a user.

19. The vehicle seat system of claim 18, wherein the pivot joint is configured to allow the tail portion to rotate through an angle in the range of 0° to 150°.

20. The vehicle seat system of claim 18, wherein the secondary seat portion is at an elevated position as compared to the main seat portion.
